(19) United States
(12) Patent Application Publication
(10) Pub. No.: US 2005/0231904 A1
(43) Pub. Date: Oct. 20, 2005

(54) CPU mounting apparatus

(75) Inventors: Yong-Min Luo, Shenzhen (CN); Wen-Shan Xu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/105,208

(22) Filed: Apr. 13, 2005

(30) Foreign Application Priority Data
Apr. 15, 2004 (CN) 200420044959.7

(51) Int. Cl. F21V 29/00

(52) U.S. Cl. 361/684

(57) ABSTRACT

A mounting apparatus for mounting a CPU to a socket includes a connecting member (10) with a first air vent (16) defined therein, a pipe member (20) with a second air vent (26) defined therein, and a base (30) with a third air vent (32) defined therein. An end of the connecting member connects with a vacuum pump (13). The other end of the connecting member connects with an end of the pipe member. The other end of the pipe member connects with the base. A through hole (22) is defined in the pipe member. The base defines a concave (35) therein to accommodate the CPU therein. The concave communicates with the third air vent. The first air vent, the second air vent and the third air vent communicate with or are separated from the atmosphere through the through hole.

### CROSS-REFERENCE TO RELATED APPLICATIONS

Relevant subject matter is disclosed in a co-pending U.S. patent application entitled “CPU mounting apparatus”, filed on Nov. 16, 2005 with the application Ser. No. 10/989,700 and assigned to the same assignee with this application.

### BACKGROUND OF THE INVENTION

1. Field of the Invention

The present invention relates to mounting apparatus for CPUs, and particularly to a mounting apparatus for readily and securely installing or removing a CPU to or from a socket.

2. Background of the Invention

Conventionally, a central processing unit (CPU) is inserted into a socket connector directly. Referring to FIGS. 5 and 6, a socket 12′ of Intel Pentium 5 CPU is mounted on a motherboard 1′. The socket 12′ comprises a plurality of pins 120′ and two slots 121′, 123′ in two sides thereof for readily mounting the CPU 13′. The CPU 13′ has a plurality of pads 130′ corresponding to the pins 120′ of the socket 12′. During installation, the CPU 13′ is inserted into the socket 12′ straightly. The CPU pads 130′ engage with the mating socket pins 120′. However, some of the pins 120′ are often damaged or bent when too much force is applied thereon or the force is inequality during forced manipulation. The damaged or bent pins cannot connect with the pads 130′ whereby a loose electrical connection is arisen. Moreover, it is rather inconvenient and laborious to insert the CPU into the socket by handwork.

What is needed is to provide a mounting apparatus which readily and securely attaches or removes a CPU to or from a socket.

### SUMMARY

A mounting apparatus in accordance with a preferred embodiment of the present invention is disclosed for mounting a CPU to a socket. The mounting apparatus includes a connecting member with a first air vent defined therein, a pipe member with a second air vent defined therein and a base with a third air vent defined therein. An end of the connecting member connects with a vacuum pump. The other end of the connecting member connects with an end of the pipe member. The other end of the pipe member connects with the base. A through hole is defined in the pipe member to communicate with the atmosphere and the second air vent. The base defines a concave therein adapted to accommodate the CPU therein. The concave communicates with the third air vent. The second air vent communicates with the first air vent and the third air vent. The first air vent, the second air vent and the third air vent communicate with or are separated from the atmosphere through the through hole.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a mounting apparatus in accordance with a preferred embodiment of the present invention;

FIG. 2 is a cross-sectional view of a base of FIG. 1, taken along line II-II;

FIG. 3 is an assembled view of FIG. 1; and

FIG. 4 is similar to FIG. 3, but viewed from another aspect.

### DETAILED DESCRIPTION OF THE INVENTION

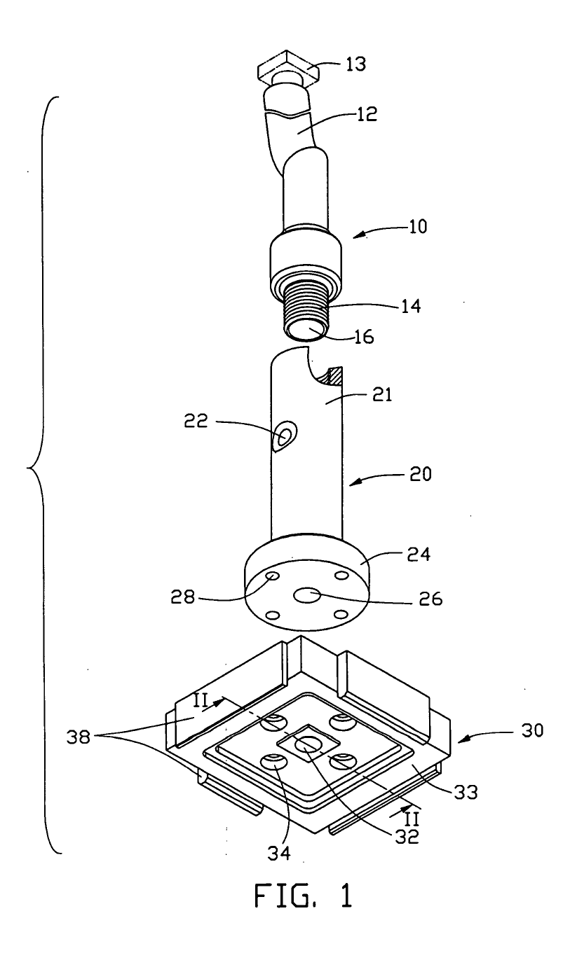

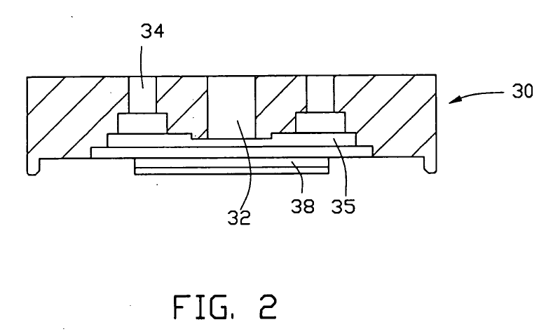

Referring to FIGS. 1 and 2, a CPU mounting apparatus in accordance with a preferred embodiment of the present invention is shown for mounting a CPU to a socket on a motherboard. The CPU mounting apparatus includes a connecting member 10, a pipe member 20 and a base 30.

The connecting member 10 is hollow, with an air vent 16 being defined therein. An end of the connecting member 10 communicates with an air-drain of a vacuum pump 13, and the other end of the connecting member 10 forms a connecting portion 14 being threaded.

The pipe member 20 having a generally T shape is hollow with an air vent 26 being defined therein. The pipe member 20 includes a first hollow portion 21 at an upper portion thereof, and a second hollow portion 24 at a lower portion thereof. The diameter of the second hollow portion 24 is greater than that of the first hollow portion 21. An inner surface of an upper portion of the first hollow portion 21 is threaded, corresponding to the connecting portion 14 of the connecting member 10. A through hole 22 communicating with the atmosphere and the air vent 26 of the pipe member 20 is defined in the first hollow portion 21. The through hole 22 can also be defined in the second hollow portion 24. A plurality of locking holes 28 is defined in a bottom of the second hollow portion 24 around the air vent 26.

The base 30 has a concave 35 in a bottom 33 thereof to accommodate the CPU therein. The concave 35 has a step corresponding to a stepped top of the CPU to accommodate the CPU tightly. Four projecting portions 38 are formed outwardly from four sides of the base 30, respectively. A bottom portion of each projecting portion 38 extends downwardly from the bottom of the base 30. A pair of opposite projecting portions 38 has different lengths. An air vent 32 is defined in the base 30 and communicates with the concave 35. A plurality of locking holes 34 is defined in the base, corresponding to the locking holes 28 of the pipe member 20.

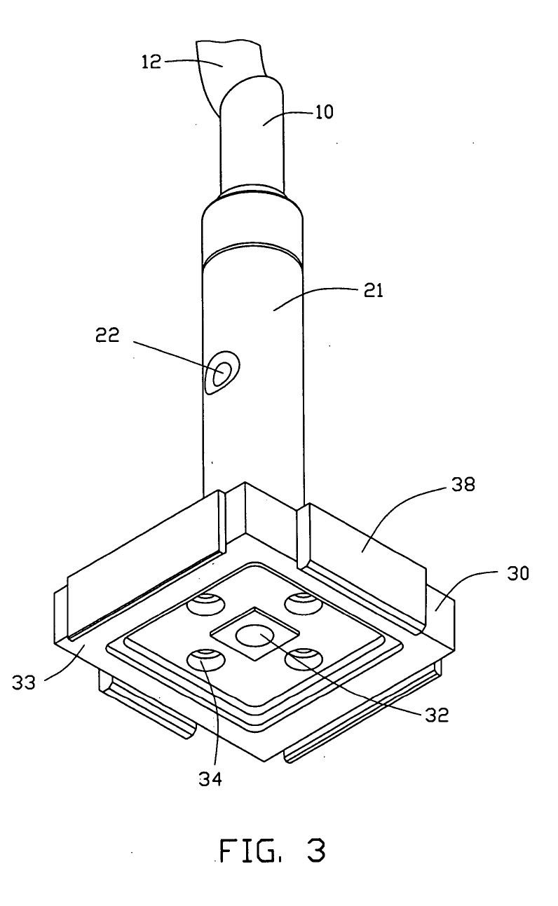

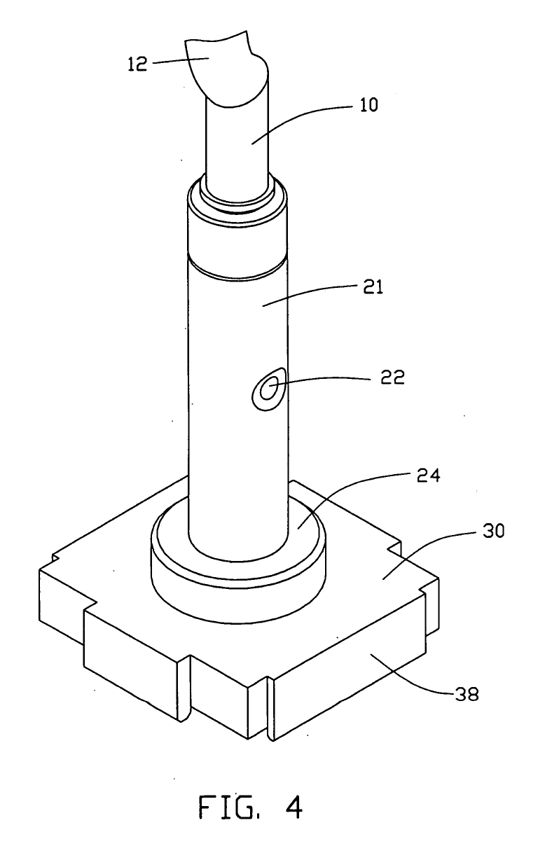

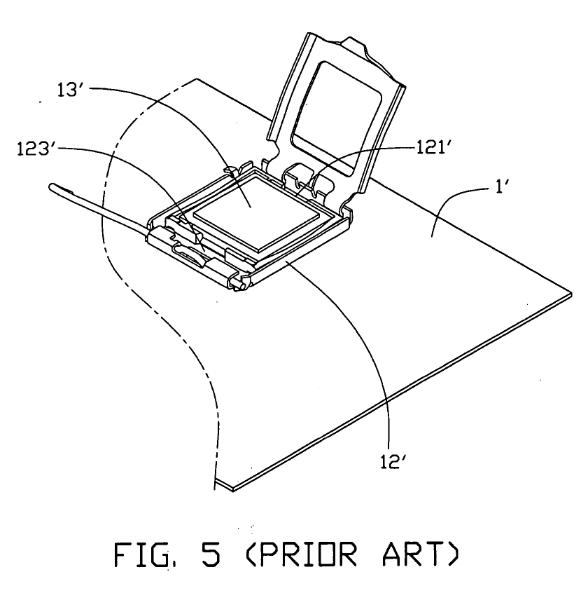

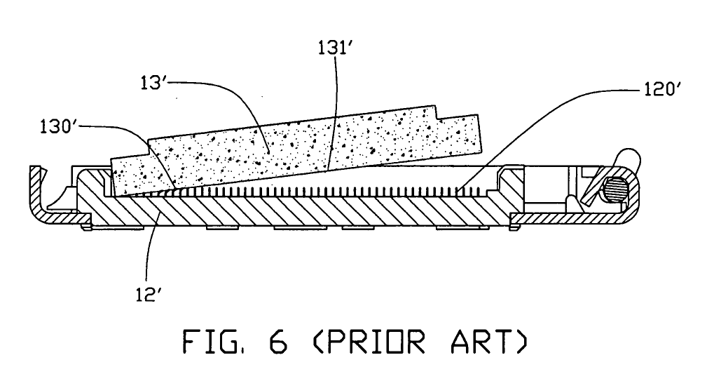

Referring also to FIGS. 1-4, in assembling the mounting apparatus, a plurality of screws extends through the locking holes 34 from the bottom 33 of the base 30 and is engaged in the locking holes 28 of the pipe member 20, to assemble the pipe member 20 to a top of the base 30. The upper portion of the pipe member 20 connects with the connecting portion 14 to assemble the connecting member 10 to the pipe member 20. The air vent 26 of the pipe member 20 communicates with the air vent 16 of the connecting member 10 and the air vent 32 of the base 30.

In assembling the CPU to the socket of the motherboard, the CPU is inserted into the concave 35. The through hole 22 is shut. The air vents 16, 26 and 32 become vacuum by the working of the vacuum pump 13. Thus, the CPU is pressed on the bottom of concave 35 by the atmosphere. A space surrounded between the bottom 33 of the base 30 and the bottom portions of the projecting portions 38 fittingly accommodates the socket of the motherboard. The different lengths of the pair of opposite projecting portions 38 can prevent the users from mistaking the direction of mounting the CPU to the socket. After the CPU is mounted to the socket, the through hole 22 is released and open. The atmosphere comes into the air vents 16, 26 and 32. Then, the air pressure inside the air vents 16, 26 and 32 is resumed to the atmosphere pressure. The CPU is thereby released. Thus, the CPU mounting apparatus can be removed from the CPU.

Additionally, the top portion of the pipe member can be made to communicate with the vacuum pump 13 directly. Thus, the connecting member 10 can be saved.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A mounting apparatus to mount a central processing unit (CPU) to a socket, the mounting apparatus comprising:
a connecting member with a first air vent defined therein, an end of the connecting member communicating with a vacuum pump;
a pipe member with a second air vent defined therein, a through hole defined in the pipe member to communicate with the atmosphere and the second air vent, an end of the pipe member connecting with the other end of the connecting member; and
a base with a third air vent defined therein, the base defining a concave therein to accommodate the CPU therein, the concave communicating with the third air vent, the second air vent communicating with the first air vent and the third air vent, the first air vent, the second air vent and the third air vent communicating with or separated from the atmosphere through the through hole.

2. The mounting apparatus as claimed in claim 1, wherein a projecting portion extends downwardly from a bottom of the base, the projecting portions and the bottom of the base form a space for fittingly accommodating the socket.

3. The mounting apparatus as claimed in claim 1, wherein the pipe member having a generally T shape comprises a first hollow portion at an upper portion thereof, and a second hollow portion at a lower portion thereof, a diameter of the second hollow portion is greater than that of the first hollow portion.

4. The mounting apparatus as claimed in claim 3, wherein a plurality of locking holes is defined in a bottom of the second hollow portion, a plurality of locking holes is defined in the base corresponding to the locking holes of the second hollow portion.

5. The mounting apparatus as claimed in claim 3, wherein an end of the connecting member connects with an air-drain of a vacuum pump, the other end of the connecting member forms a threaded connecting portion, an inner surface of an upper portion of the first hollow portion of the pipe member is threaded corresponding to the connecting portion.

6. The mounting apparatus as claimed in claim 3, wherein the through hole of the pipe member is defined in the first hollow portion.

7. A mounting apparatus to mount a central processing unit (CPU) to a socket, the mounting apparatus comprising:
a pipe member with a first air vent defined therein, a through hole defined in the pipe member to communicate with the atmosphere and the first air vent, an end of the pipe member connecting with a vacuum pump; and
a base with a second air vent defined therein, the base defining a concave therein to accommodate the CPU therein, the concave communicating with the second air vent, the second air vent communicating with the first air vent, wherein when the through hole is shut, the vacuum pump works to suck the CPU in the concave.

8. The mounting apparatus as claimed in claim 7, wherein a plurality of projecting portions extends downwardly from a bottom of the base, the projecting portions and the bottom of the base form a space for fittingly accommodating the socket.

9. The mounting apparatus as claimed in claim 8, wherein one of the projecting portions has different length with the other of the projecting portion, for preventing the direction of mounting the CPU to the socket from being mistaken.

10. The mounting apparatus as claimed in claim 7, wherein the mounting apparatus further comprises a connecting member with a third air vent defined therein, an end of the connecting member communicates with the vacuum pump, the other end of the connecting member connecting with an upper portion of the pipe member.

11. The mounting apparatus as claimed in claim 10, wherein the pipe member having a generally T shape comprises a first hollow portion at an upper portion thereof and a second hollow portion at a lower portion thereof, a diameter of the second hollow portion is greater than that of the first hollow portion.

12. The mounting apparatus as claimed in claim 11, wherein a plurality of locking holes is defined in a bottom of the second hollow portion, a plurality of locking holes is defined in the base corresponding to the locking holes of the second hollow portion.

13. The mounting apparatus as claimed in claim 11, wherein the through hole of the pipe member is defined in the first hollow portion.

14. A method to mount a central processing unit (CPU) to a socket for electrical connection therebetween, comprising the steps of:
providing a base to accommodate and hold said CPU therein;
moving said base with said held CPU toward said socket;
guiding motion of said base relative to said socket so as to precisely and directly position said CPU to a final electrically connecting location next to said socket; and
releasing said CPU from said base.

15. The method as claimed in claim 14, wherein said motion of said base is guided by at least one projecting portion extending from a bottom of said base, and said socket is capable of fittingly accommodating between said at least one projecting portion and said bottom of said base before said CPU reaches said final connecting location.

16. The method as claimed in claim 14, wherein said CPU is held by means of working of a vacuum pump through said base, and released due to neutralization of said working of said vacuum pump via a hole.
